(19) United States
(12) Patent Application Publication
(10) Pub. No.: US 2010/0142922 A1
(43) Pub. Date: Jun. 10, 2010

(54) DIGITAL LIGHT PROCESSING ANTI-CAMCORDER SWICH

(75) Inventor: Mark Alan Schultz, Hamilton, IN (US)

Correspondence Address: Robert D. Shedd, Patent Operations;THOMSON Licensing LLC, P.O. Box 5312, Princeton, NJ, 08543-5312, US

(73) Assignee: THOMSON LICENSING, BOULOGNE-BILLANCOURT (FR)

(21) Appl. No.: 12/733,201

(22) PCT Filed: Aug. 21, 2007
(86) PCT No.: PCT/US2007/018482

§ 371 Date: Feb. 17, 2010

(51) Int. Cl. H04N 5/91

(52) U.S. Cl. 386/94; 386/E05.001

(57) ABSTRACT

A method and apparatus are described for controlling anti-camcording features for individual pixels of a digital content display system, including receiving pixel component values, receiving an indication of whether anti-camcording is enabled, adjusting the pixel component values in response to the anti-camcording indication and based on the pixel component values and loading a bitmap with the adjusted pixel component values.

### FIELD OF THE INVENTION

The present invention relates to anti-camcording of digital cinema image frames in general, and in particular, to the use of a switch to control anti-camcorder features for individual pixels.

### BACKGROUND OF THE INVENTION

Illegal camcording in digital cinema theatres adversely affects the authorship rights of movie creators and the business of production studios and theatre chains. There are different methods to protect against piracy. Some of the protection schemes are annoying for the audience. Other protections schemes, for example, those which are laser-based, are dangerous for the movie viewers or have doubtful efficiency.

Significant progress has been made in the domain of digital projection technology, which has become a potential replacement for the classic film projection. Recent research investigated the possibilities of using some features of the digital projector, not available in the traditional film projector.

The optical semiconductor that is at the heart of every current digital light processing (DLP®) projection system was invented at Texas Instruments. It contains a rectangular array of up to 2 million hinge-mounted microscopic mirrors. When a DLP® chip is coordinated with a digital video or graphic signal, a light source, and a projection lens, its mirrors can reflect a digital image onto a screen or other surface. DLP® is used in both theater projection systems, HDTVs and even printing systems. DLP® technology is a display technology that has good brightness, relatively low cost and some flexibility.

One distinctive feature of digital projectors, based on micro-mirror devices and DLP® technology, is their image bit-plane manipulation. Digital cinema employs 12 bits of quantized. digital video. Every image bit is projected by DLP® projector for a proportional sub-frame time on the theatre screen. The lesser bits (darker scene objects) are projected for a shorter period of time within a video frame. The most significant image bits (brightest scene objects) are projected for the longest time within the video frame. Thus, the image bit-planes are shaped, altogether creating picture perception within the Human Visual System (HVS).

Anti-camcording methods allow operators of feature film digital projection theatres to increase the level of protection against piracy. A video camera, which is used to illegally record/camcord movies projected on a theatre screen, will record the image content with an invisible artifact. The invisible artifact will become visible when the recorded image frames/pictures/images are reproduced on a video display. As used herein “/”, denotes the same of similar components or acts. That is, “/” can be taken to indicate alternative terms for the same or similar components or acts.

Conventional techniques either modulate the data on the input, to the digital cinema (DC) projector, or configure the present architecture of the projector to be fully active in anti-camcorder mode (AC) or fully active without anti-camcording for the entire movie. The problem with these techniques is that what is desirable is a natural blend of the two extremes so that it is possible to switch between AC mode and normal mode at a frame level or better yet at a pixel level.

Various proposals have been made to modify the bitmaps of a DLP® projector for anti-camcording mode. Most of these proposals require multiple layers and control of bitmaps of the Datapath Formatter just before the digital micro-mirror device (DMD) which may require large changes in the current DLP® architecture.

### SUMMARY OF THE INVENTION

For imaging applications the memory cells that hold the information/data for the micro-mirrors have data loading circuitry that permits an entire row of data to be loaded at one time. Most anti-camcorder approaches require multiple bit plane loading and pixel level control of bitmaps. These approaches may require large changes in the DLP® architecture. The present invention uses a single table for the bitmaps so no major architecture changes are needed in the DLP® projectors, yet anti-camcorder features are still possible for each individual pixel. The present invention loads one custom bitmap that has very different multiplexing assignments between the even and odd least significant bit (LSB) values of the pixels. Careful selection of the even and odd pixel values allows real time processing to enable the anti-camcorder or normal processing modes on a per pixel basis by using the LSB of each component as a switch. Also described is how to recover the loss of this bit by using a special frame toggle bit to control the rounding process of the data during display.

DLP® chips use pulse width modulated (PWM) light to adjust the gray scale of pixel values. The PWM data is built by loading bit planes into the DLP® processor to adjust the time period and switching of the mirrors. Researchers have proposed modifying these bit planes so that one bit plane could be loaded for an anti-camcorder (AC) mode and another bit plane could be loaded for a normal mode. The main difference is the clustering of the light in the PWM pattern to exploit the differences in sampling between a camcorder and the human vision system.

The present invention concentrates the light at certain points in time and has no light during other points in time. That is, a bright light is projected onto the display screen followed by darkness over a time interval instead of dim light all the time. This makes the shuttering of a camcorder difficult since it cannot average the pixels over time like the human vision system (eye). The present invention accomplishes this by loading different pattern files into the look up tables for the DMD to either make the pictures normal or to load different anti-camcorder patterns over time to create a disturbing result in the illegal recording of the digital content by a video camera. The audience should normally not be able to see the difference while a display of the illegal recording will have visible artifacts. Different patterns can be projected on different parts of the screen or the intensity of the distribution of light over time can be varied. The individual pixels and their modulation can be controlled by using the LSBs of the video as a switch to actually add static or dynamic text and graphics. This allows pixel level resolution for the anti-camcorder techniques.

Since a digital cinema projector needs both normal and anti-camcorder modes, either the AC mode is enabled or not enabled for the entire block or even the entire frame. It is not known if the current DLP® architecture allows the changing of the bit planes within a frame or even on a frame boundary. What would be very desirable and advantageous is the ability to control the AC mode of each pixel in the frame. The current DLP® architecture does not allow this to occur unless the actual data coming into the projector is carefully managed. The present invention uses the LSB of each pixel component's value to switch between anti-camcorder mode or normal mode. The resulting light on the screen is the same to the viewer but the camcorder will obtain different results than the direct viewer due to the varying PWM patterns for the pixels that have the AC mode enabled.

A method and apparatus are described for controlling anti-camcording features for individual pixels of a digital content display system, including receiving pixel component values, receiving an indication of whether anti-camcording is enabled, adjusting the pixel component values in response to the anti-camcording indication and based on the pixel component values and loading a bitmap with the adjusted pixel component values.

### BRIEF DESCRIPTION OF THE DRAWINGS

The present invention is best understood from the following detailed description when read in conjunction with the accompanying drawings. The drawings include the following figures briefly described below:

FIG. 1 shows both a conventional DLP® system (top schematic figure) and where the anti-camcorder module is added to a DLP® system (bottom schematic figure).

FIG. 2A is a detailed view of the anti-camcorder module shown in FIG. 1.

FIG. 2B is a flowchart of the anti-camcording method in accordance with the principles of the present invention.

FIG. 3 is pseudo-code of the detailed operations of the Data Rounding module.

FIG. 4 shows the final stage of the processing of the Datapath Formatter.

### DETAILED DESCRIPTION OF THE PREFERRED EMBODIMENTS

DLP® projectors are capable of reproducing images at different frame rates, or number of projected Frames Per Second (FPS). The DLP® projection process allows for smooth changes from one speed to another, e.g. from 24 FPS (classic film rate) to 30 FPS (video rate) to 60 FPS or even higher.

AC techniques usually use higher frame rates due to flicker problems with luma or chroma modulation. When higher frame rates are used, the bit depth of the DLP® displays is reduced due to less time to multiplex the micro-mirrors. Given that this can occur, the present invention makes use of the least-significant-bit (LSB) that might normally be deleted during the processing at higher frame rates. The present invention not only explains how to use the LSB as a switch but also how to recover full bit depth by using a rounding method and a separate frame toggle switch.

The present invention uses a single table for the bitmaps so no major architecture changes are needed in the DLP® projectors, yet anti-camcorder features are still possible for each individual pixel. The present invention loads one custom bitmap that has very different multiplexing assignments between the even and odd LSB values of the pixels. The main difference in these even and odd pixel value patterns is how the light is distributed in the PWM data of each micro-mirror across a number of frames. If the anti-camcorder feature is enabled on a unique pixel, each pixel is processed normally until it reaches the anti-camcorder processing.

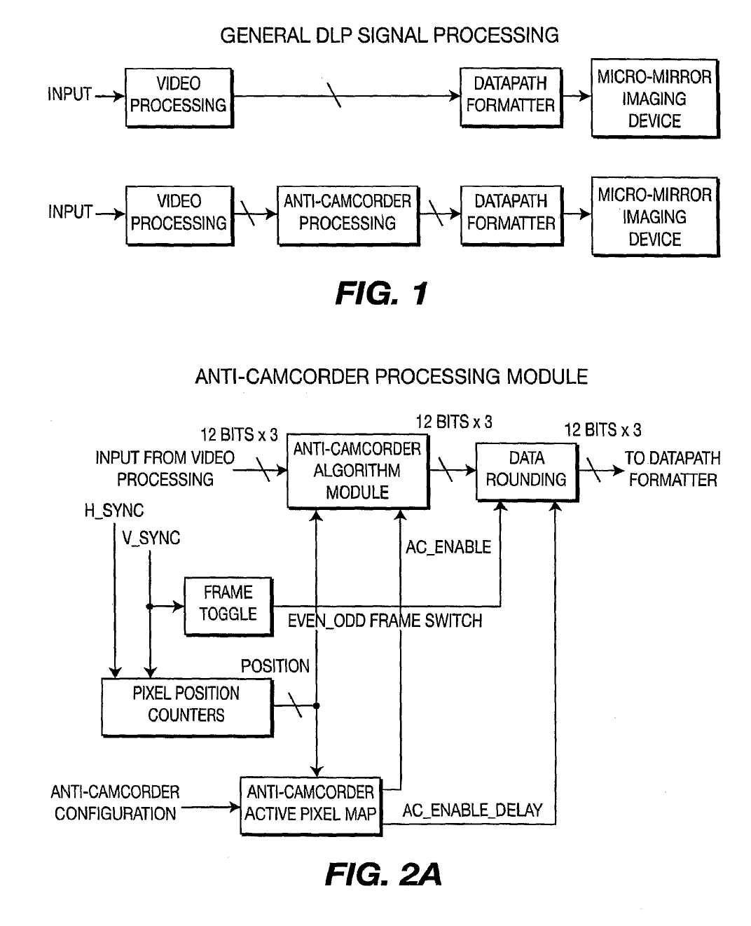

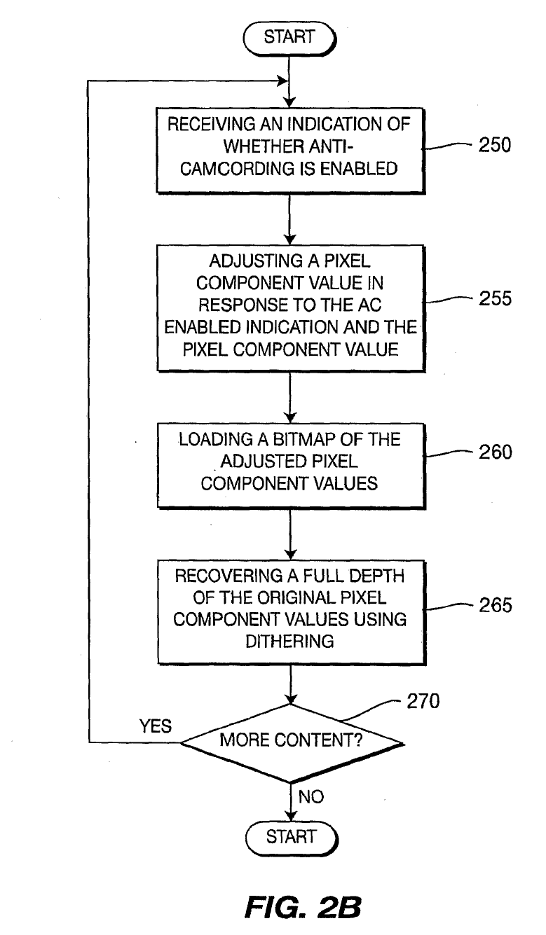

Referring now to FIG. 1, which shows both a conventional DLP® system (top schematic diagram) and where the anti-camcorder module is added to a DLP® system (bottom schematic diagram). Referring now to FIG. 2, which is a detailed view of the anti-camcorder module shown in FIG. 1, at the AC Algorithm module 205, the pixel can be processed by AC methods of the present invention when the AC Active Pixel Map module 210 sends out the AC-Enable=1 or the pixel is just passed through the AC module of the present invention when AC-Enable=0.

The next step involves adding the switch for the bit plane pixel component value, which is handled in the Data Rounding module 215. The Even_Odd_Frame_Switch toggles with every frame to help add dithering to the Data Rounding module. The Even-Odd Frame Switch signal is generated by the Frame Toggle module 220 based on the v-sync. The Frame Toggle Module changes the state between “1” and “0” on the rising edge of each v-sync pulse. Thus, the Frame Toggle Module has a frequency that is half of the v-sync frequency. The AC_Enable_Delay signal is a delayed AC_Enable switch signal that indicates if the pixel was modified in the AC Algorithm module 205. The AC_Enable_Delay signal is generated by the AC Active Pixel Map module 210 based on input that the AC Active Pixel Map module received from the AC Algorithm module 205. The output of the Data Rounding module 215 goes to the Datapath Formatter.

The Pixel Position Counters Module 225 keeps track of the physical x-y position of the pixels on the display screen. This x-y position is along with the Anti-camcorder Active Pixel Map Module 210 to enable special patterns of anti-camcorder information (for example, ILLEGAL COPY) to appear on the display screen.

Each of the modules on FIG. 2A can be implemented as software, hardware or firmware or any combination thereof including applications specific integrated circuits (ASICs) or field programmable gate arrays (FPGAs).

FIG. 2B is a flowchart of the anti-camcording method in accordance with the principles of the present invention. The method is performed in the AC Processing Block (shown in FIG. 1 and in detail in FIG. 2A). At 250 an indication is received as to whether anti-camcording is enabled. The pixel component values are received from the video processing block of the DLP® projection system. The pixel component values are adjusted in response to the anti-camcording indication and the value of the pixel components at 255. The adjusted pixel component values are loaded into a bitmap at 260. Recovery of the full bit depth of the original pixel component values is performed at 265 using dithering. A test is performed at 270 to determine if there is more content. If there is more content the process continues. If there is no more content then the process ends.

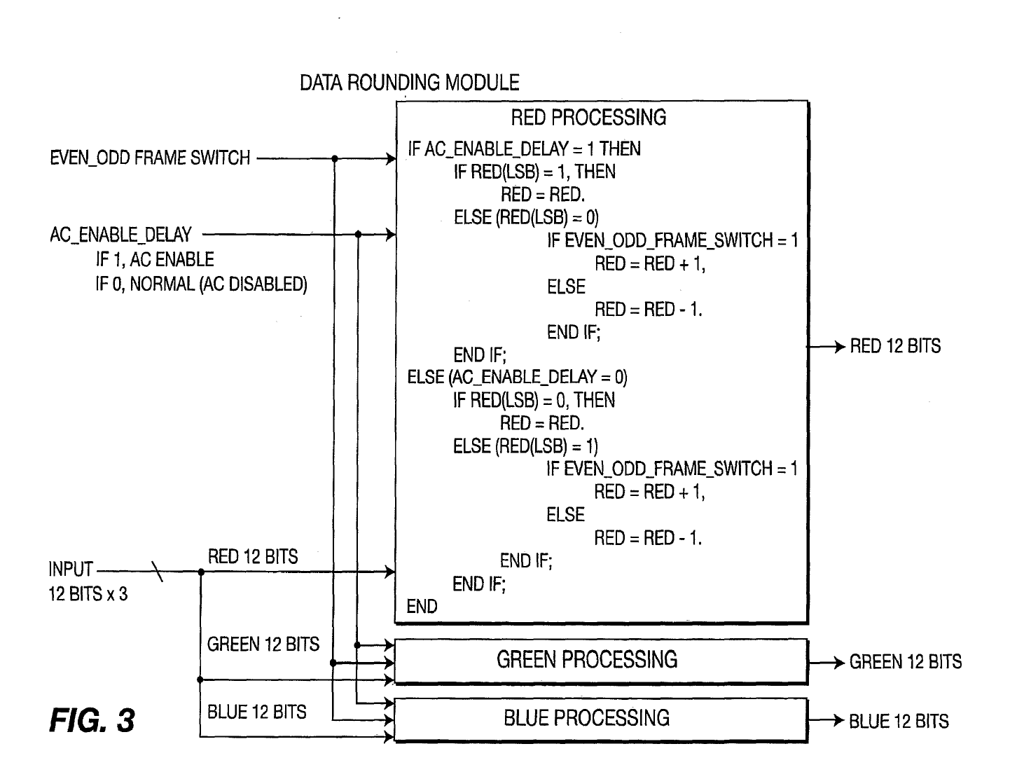

Details of the operations performed in the Data Rounding module 215 are shown on FIG. 3. The Data Rounding module is used to recover the full bit depth of the original data. FIG. 3 is pseudo-code and is equivalent to if not more detailed than a flowchart. The use of pseudo-code is not intended to limit the implementation to software. The operations of the Data Rounding module can be implemented as software, hardware or firmware or any combination thereof including applications specific integrated circuits (ASICs) or field programmable gate arrays (FPGAs). There are three processing paths depending on whether the pixel is red, green or blue. In the alternative, the color of the pixel could be input to a single processing path which could be adjusted based on the color of the pixel. The processing for a red pixel is detailed. The processing for a green or a blue pixel is identical except for the color of the pixel so will not be described further. The processing algorithm for each pixel color receives three signals—the Even_Odd Frame Switch signal from the Frame Toggle module 220, the AC_Enable_Delay signal from the AC Active Pixel Map module 210 and 12 bits of data (pixel component values) from the video processing (shown on FIG. 1).

If AC is enabled (AC_Enable_Delay=1) on a pixel component, the output value of the LSB must be equal to 1 or equal to 0. This is enough to provide signaling to help select the PWM of a pixel for either normal or AC enabled patterns.

The processing can be taken a step further by adding dithering to the rounding process with the following logic:

If the pixel component value needs to change to reflect the proper switch, then a one needs to be added or subtracted from the pixel component value. By toggling the addition or subtraction with every frame, the original value is displayed when the light on the output is averaged between frames. This is a frame based dither when the data has been modified.

If the pixel component value does not need to be changed (since there is a 50/50 chance of it being correct) no adding or subtracting or dithering is needed.

If it is desirable to write a word or words on the screen (for example, ILLEGAL COPY) for the camcorder, the pixel values in the letters are assigned to 1 and the rest of the background is assigned to 0 for the entire horizontal/vertical array. This pattern is then used to control the AC_Enable_Delay switch by sending out either a 1 or 0 for each unique pixel.

Specifically, referring to the pseudo-code on FIG. 3, upon receipt of the 12 input bits (pixel component values) of data (Red), if the AC_Enable_Delay signal is 1 (AC mode is enabled) then the LSB of the input data is checked. If the LSB of the input data is a 1 then the input data is not adjusted or changed. If, however, the LSB of the input data is not 1 (it must then be 0) then the Even_Odd Frame switch signal is checked. If the Even_Odd Frame switch signal is 1 then the input data is incremented by 1. If the Even_Odd Frame switch signal is 0 then the input data is decremented by 1.

Still referring to FIG. 3, if the AC_Enable_Delay signal is 0 (AC mode is not enabled) then the LSB of the input data is checked. If the LSB of the input data is 0 then the input data is not adjusted or changed. If, however, the LSB of the input data is not 0 (it must then be 1) then the Even-Odd Frame Switch signal is checked. If the Even Odd Frame switch signal is 1 then the input data is incremented by 1. If the Even_Odd Frame switch signal is 0 then the input data is decremented by 1.

Below is an example of a few pixels:

(P1, P2, P3, P4, P5) have values of 143, 345, 322, 712 and 625 respectively. If P2 and P4 are to be anti-camcorder enabled and P1, P3 and P5 are to be in normal mode, the Data Rounding block would perform the following processing:

P1=143 (which is odd) and the AC_Enable_Delay signal=0 (normal mode) but so on the first frame P1 is incremented by 1 to yield 144 and on the second frame P1 is decremented by 1 to yield 142. Note that this always delivers an even result but averages to the original value.

P2=345 (which is odd) and AC_Enable_Delay=1 (AC mode) on so this component pixel value is unchanged.

P3=322 (which is even) and AC_Enable_Delay=0 (normal mode) this pixel component value is unchanged.

P4=712 (which is even) and AC_Enable_Delay=1 (AC mode) so on the first frame P4 is incremented by 1 to yield 713 and on the next frame P4 is decremented by 1 to yield 711, then on the next frame increment by 1 add 1 to yield 713 . . . to make odd values that average to 712.

P5=625 (which is odd) and AC_Enable_Delay=0 (normal mode) so on the first frame P5 is incremented by 1 to yield 626 and on the next frame P5 is decremented by 1 to yield 624, then on the next frame increment by 1 to yield 626 . . . to make even values that average to 625.

When the even pixels are pulse wave modulated, the light energy is spread evenly across the frames in a normal manner. When the odd pixels are pulse are modulated, the light energy is lumped heavily on one “on” time with a large gap to the next “on” time.

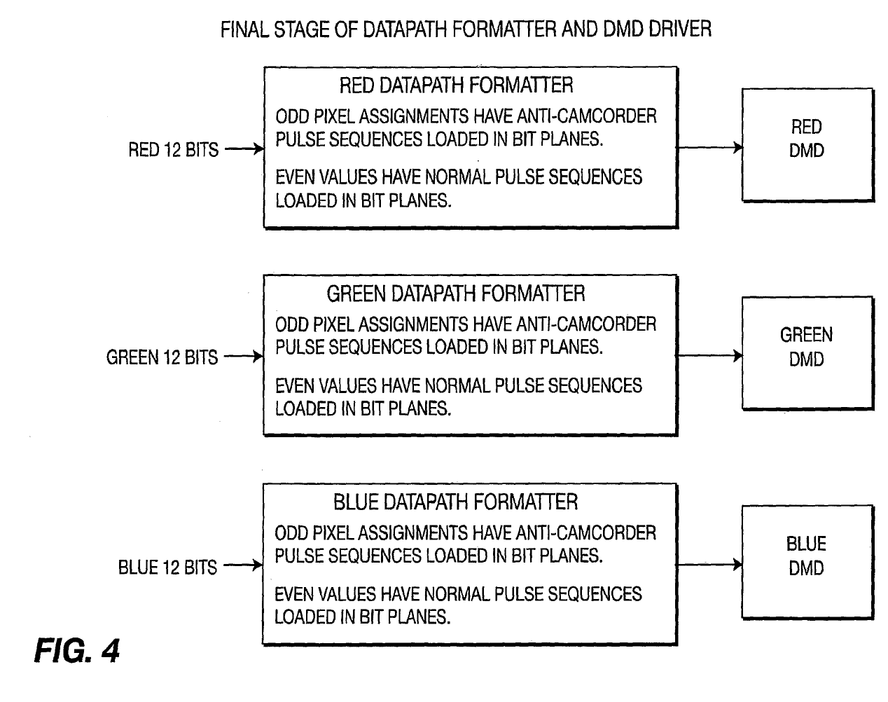

FIG. 4 shows the final stage of the Data Formatter. As noted above, the Data Formatter modules could be implemented as a single module with color as an input parameter or as shown using 3 separate modules—one for each color (red, green or blue).

It should be noted that while the best mode to practice the invention is a projection apparatus, the invention could be practiced as an “add-on” device to a projection apparatus. The “add-on” device could be put in to the projection apparatus or be external to the projection apparatus but able to communicate with the projection apparatus.

It is to be understood that the present invention may be implemented in various forms of hardware, software, firmware, special purpose processors, or a combination. thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method, said method comprising:
receiving pixel component values;
receiving an indication of whether anti-camcording is enabled;
adjusting said pixel component values in response to said anti-camcording indication and based on said pixel component values; and
loading a bitmap with said adjusted pixel component values.

2. The method according to claim 1, further comprising recovering a full bit depth of said pixel component values.

3. The method according to claim 1, further comprising storing said bitmap for display by a digital micro-mirror device of a digital light processing system.

4. The method according to claim 1, wherein if said pixel component value is odd and anti-camcording is not enabled then said pixel component value is one of incremented and decremented every frame to make said pixel component value even.

5. The method according to claim 1, wherein if said pixel component value is odd and anti-camcording is enabled then said pixel component value is unchanged.

6. The method according to claim 1, wherein if said pixel component value is even and anti-camcording is not enabled then said pixel component value is unchanged.

7. The method according to claim 1, wherein if said pixel component value is even and anti-camcording is enabled then said pixel component value is one of incremented and decremented every frame to make said pixel component value odd.

8. The method according to claim 2, wherein if a least significant bit of said pixel component value is equal to 1 and anti-camcording is enabled then said pixel component value is unchanged.

9. The method according to claim 2, wherein if a least significant bit of said pixel component value is equal to 1 and anti-camcording is not enabled then said pixel component value is one of incremented and decremented every frame to make said pixel component value even.

10. The method according to claim 2, wherein if a least significant bit of said pixel component value is equal to 0 and anti-camcording is enabled then said pixel component value is one of incremented and decremented every frame to make said pixel component value odd.

11. The method according to claim 2, wherein if a least significant bit of said pixel component value is equal to 0 and anti-camcording is not enabled then said pixel component value is unchanged.

12. An apparatus, comprising:
means for receiving pixel component values;
means for receiving an indication of whether anti-camcording is enabled;
means for adjusting said pixel component values in response to said anti-camcording indication and based on said pixel component values; and
means for loading a bitmap with said adjusted pixel component values.

13. The apparatus according to claim 12, further comprising means for recovering a full bit depth of said pixel component values.

14. The apparatus according to claim 12, further comprising means for storing said bitmap for display by a digital micro-mirror device of a digital light processing system.

15. The apparatus according to claim 12, wherein if said pixel component value is odd and anti-camcording is not enabled then said pixel component value is one of incremented and decremented every frame to make said pixel component value even.

16. The apparatus according to claim 12, wherein if said pixel component value is odd and anti-camcording is enabled then said pixel component value is unchanged.

17. The apparatus according to claim 12, wherein if said pixel component value is even and anti-camcording is not enabled then said pixel component value is unchanged.

18. The apparatus according to claim 12, wherein if said pixel component value is even and anti-camcording is enabled then said pixel component value is one of incremented and decremented every frame to make said pixel component value odd.

19. The apparatus according to claim 13, wherein if a least significant bit of said pixel component value is equal to 1 and anti-camcording is enabled then said pixel component value is unchanged.

20. The apparatus according to claim 13, wherein if a least significant bit of said pixel component value is equal to 1 and anti-camcording is not enabled then said pixel component value is one of incremented and decremented every frame to make said pixel component value even.

21. The apparatus according to claim 13, wherein if a least significant bit of said pixel component value is equal to 0 and anti-camcording is enabled then said pixel component value is one of incremented and decremented every frame to make said pixel component value odd.

22. The apparatus according to claim 13, wherein if a least significant bit of said pixel component value is equal to 0 and anti-camcording is not enabled then said pixel component value is unchanged.
